(19) United States
(12) Patent Application Publication
(10) Pub. No.: US 2008/0111074 A1
(43) Pub. Date: May 15, 2008

(54) METHOD FOR INFRARED IMAGING OF SUBSTRATES THROUGH COATINGS

(75) Inventors: John Douglas Weir, Huntington, NY (US); Robert John Christ, Brentwood, NY (US); Nils Jakob Fonneland, Lake Grove, NY (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Northrop Grumman Corporation, Los Angeles, CA (US)

(21) Appl. No.: 11/742,751

(22) Filed: May 1, 2007

Related U.S. Application Data
(63) Continuation-in-part of application No. 11/506,701, filed on Aug. 18, 2006.
Application No. 11/506,701 is a continuation-in-part of application No. 10/971,217, filed on Oct. 22, 2004, now Pat. No. 7,164,146.

(51) Int. Cl. G01J 5/00

(52) U.S. Cl. 250/338.1

(57) ABSTRACT

A system for visual inspection of coated substrates is disclosed. Painted substrates can be inspected for environmental and physical damage such as corrosion and cracks without removing the paint through the use of infrared imaging. The present invention provides the ability to view abnormalities or defects in the substrate at an increased depth of field. This is accomplished by taking multiple images of the substrate at different focal planes then using computer software to merge the images. The merged image is in focus across the different focal planes and may also be viewed in three-dimensions.

### CROSS REFERENCE TO RELATED APPLICATIONS

This application is a continuation-in-part of U.S. patent application Ser. No. 11/506,701 filed Aug. 18, 2006, which is a continuation-in-part of U.S. patent application Ser. No. 10/971,217 filed Oct. 22, 2004, both of which are herein incorporated by reference.

### GOVERNMENT CONTRACT

The United States Government has certain rights to this invention pursuant to the funding and/or contracts awarded by the Strategic Environmental Research and Development Program (SERDP) in accordance with the Pollution Prevention Project WP-0407. SERDP is a congressionally mandated Department of Defense (DOD), Department of Energy (DOE) and Environmental Protection Agency (EPA) program that develops and promotes innovative, cost-effective technologies.

### FIELD OF THE INVENTION

The present invention relates to imaging of substrates through coatings, and more particularly relates to a camera system for infrared imaging of defects and other structural features of coated objects such as aircraft components.

### BACKGROUND INFORMATION

Aircraft components are subject to constant degradation such as corrosion and cracking caused by environmental and operational conditions. Although the application of coatings, such as paints, reduces corrosion problems substantially, they typically cannot eliminate them entirely. Furthermore, forces experienced during flight can result in damage which a coating of paint cannot mitigate, such as stress defects and cracking. In order to ensure that aircraft are ready for flight, periodic inspections are necessary.

Inspection of aircraft components traditionally includes visual inspection. When visually inspecting aircraft components, the coating used to protect the components becomes an obstacle because it may hide structural defects or features beneath the coating. It is therefore necessary to strip the component assembly or aircraft in question of its paint before a proper visual inspection can be performed. Afterward, a new coating of paint must be applied. This process results in substantial expense in the form of labor and materials, raises environmental concerns, and requires a great amount of time. Furthermore, the visual inspection can be unreliable due to limitations of the human eye.

In addition to visual inspection, active thermography techniques have been proposed for inspection of various components. One such technique utilizes a transient heat source to heat the component, followed by detection of a transient heat signature on the surface of the component to determine the presence of anomalies or defects. However, such techniques require specialized equipment and controls to generate the necessary transient heating, and are inefficient because detection of the transient thermal signature can require a significant amount of time.

U.S. Published Patent Application No. US 2004/0026622 A1, which is incorporated herein by reference, discloses a system for imaging coated substrates which utilizes an infrared (IR) light source. The IR light shines on the object and is reflected to a focal plane array, also referred to as a detector.

U.S. application Ser. No. 10/971,217, which is incorporated herein by reference, discloses a system for detecting structural defects and features of coated substrates using a blackbody self-illumination technique.

These methods are significant improvements when compared to visual inspection. However, Depth of Field (DOF) in IR cameras is limited similar to standard optical systems. In optics, DOF is the distance in front of and behind the subject which appears to be in focus. For any given lens setting, there is only one distance at which a subject is precisely in focus. Focus falls off gradually on either side of that distance, so there is a region in which the blurring is tolerable often termed “circle of confusion”. IR cameras similarly have only one distance at which a subject is precisely in focus. This limits the ability of an observer to see the details of the bottom of a non-flat plane, such as a pit or scratch, and at the same time see the detail at the top of the scratch or pit.

The present invention has been developed in view of the foregoing.

### SUMMARY OF THE INVENTION

One embodiment uses an optical detector, such as an infrared camera tailored to view substrates through a coating, to take an image at a top focal plane. Then an image is taken at a bottom focal plane within the same field of view. A series of images within this field of view is then taken between the top and bottom focal plane. Each image is recorded and stored locally or transmitted to a computer. Software that incorporates an appropriate algorithm merges the images. The algorithm selects only the focused portion of each image and combines these focused portions into one image.

An aspect of the present invention is to provide a system for imaging a substrate through a coating on the substrate comprising an infrared camera to receive infrared radiation from the substrate at different focal planes, wherein the infrared camera converts the infrared radiation to an image at each focal plane, means for combining the images at the different focal planes into a merged, image and a device for conveying the merged image

Another aspect of the present invention is to provide a method for imaging a substrate through a coating on the substrate, comprising: receiving infrared radiation from the substrate into an infrared camera, focusing the camera on a first focal plane of the substrate, recording a first image at the first focal plane, focusing the camera on a second focal plane of the substrate, recording a second image at the second focal plane, and merging the first and second images together to form a focused image.

Another aspect of the present invention is to provide a method for imaging a coating on the substrate, comprising receiving infrared radiation from the substrate into an infrared camera, adjusting the distance between the camera and the substrate to focus the camera on a first focal plane of the substrate, recording an image at the first focal plane, adjusting the distance between the camera and the substrate to focus the camera on a second focal plane of the substrate, recording an image at the second focal plane, and merging the images of the first and the second focal planes together to form a focused image.

### BRIEF DESCRIPTION OF THE DRAWINGS

FIG. 1 schematically illustrates and infrared imaging system for detecting the structure of a substrate under a coating including an infrared camera for detecting blackbody radiation from the coated substrate in accordance with one embodiment of the present invention.

FIG. 2 schematically illustrates an infrared imaging system with an infrared source, a first and a second polarizer, an optical filter and a focal plane array for detecting reflected infrared radiation from a coated substrate in accordance with another embodiment of the present invention.

FIG. 3 is a schematic illustration of the relations between a focal plane, a lens and an image.

FIG. 4 schematically illustrates image stacking with the infrared imaging system of FIG. 1.

FIG. 5 is a schematic illustration of the concept of image stacking as it relates to infrared images.

FIG. 6 schematically illustrates merging of individual infrared images.

FIG. 7 schematically illustrates how the present system may be used to scan an aircraft component in accordance with an embodiment of the present invention.

FIGS. 8-12 are photos taken of a pit within a substrate covered with a coating according to one embodiment of the present invention, wherein the photos are taken at varying focal planes.

FIG. 13 is a merged image created by combining the images of FIGS. 8-12 of varying focal planes according to one embodiment of the present invention.

FIG. 14 is a three dimensional image of the pit shown in FIGS. 8-13 according to one embodiment of the present invention.

FIG. 15 is a chart showing depth and width of the pit as shown in FIGS. 8-14 according to one embodiment of the present invention.

FIG. 16 is a topographical image of the pit shown in FIGS. 8-15 according to one embodiment of the present invention.

### DETAILED DESCRIPTION

The present invention provides improved inspection of substrates that are coated with paints, polymers and other types of coatings. Most paints and polymer coatings have a region of significantly reduced electromagnetic radiation absorption and scattering in the mid IR region as compared to the visible spectral region. This effectively opens a window of visibility where certain IR imaging cameras can see through coatings to the underlying substrates. Often spectral filters are used to further enhance the image by increasing the apparent transparency of the coating. Coatings may include one or more of the following examples: paint, a composite matrix material, primer, top coat and intermediate coats. The coated substrates can be inspected for markings or environmental and physical damage such as corrosion and cracks without removing the paint.

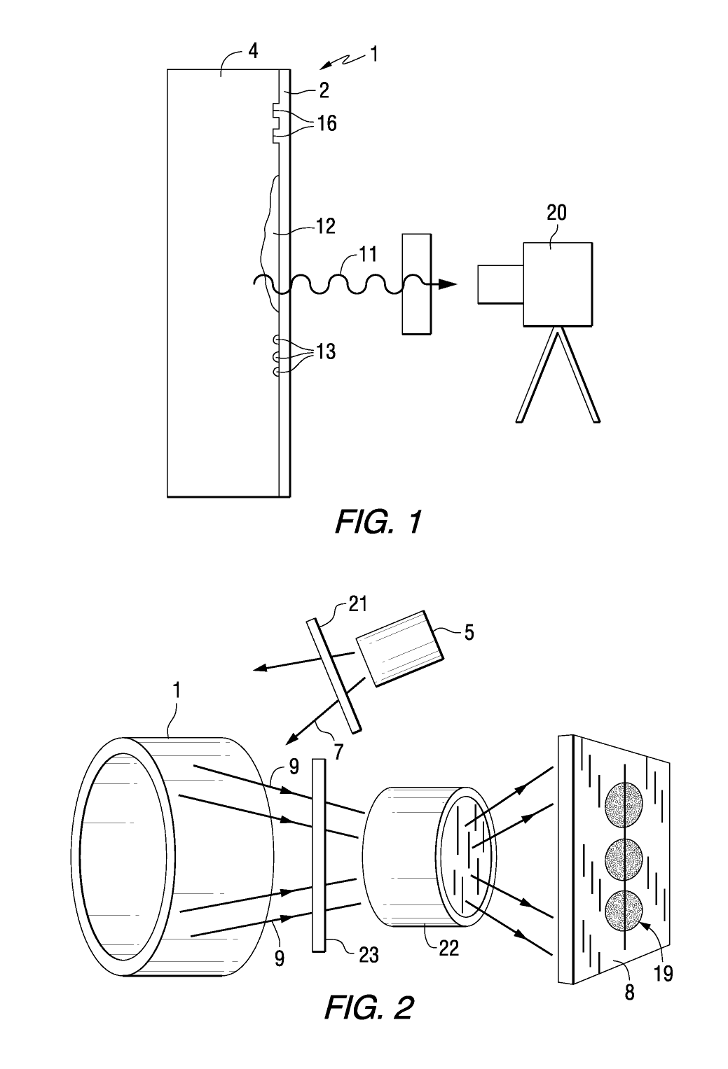

As shown in FIG. 1, an object 1 including a substrate 4 to be inspected and a coating 2 on top of the substrate 4 may include various types of structural features. The structural features may be located on the surface of the substrate 4 under the coating 2. For example, surface features may be provided on the surface of the substrate 4 below the coating 2. Examples of surface features include indicia 16 such as alphanumeric symbols, marks, codes, part numbers, bar codes and the like. The substrate may also include surface defects such as corrosion 12, pits 13, cracks 14, and other like defects. Cracks 14, voids 15, inclusions 16 and other things below the surface of the substrate are well detected by the present invention for transmissive non-metallic substrates, such as, a composites, like fiberglass, boron fiber or graphite, synthetic fibers, rubbers and plastics.

In the embodiment shown FIG. 1, an infrared camera 20 receives blackbody radiation 11 from the coated substrate 4. The radiation 11 detected from the substrate is steady state blackbody radiation. As used herein, the term “steady state blackbody radiation” means the radiation naturally generated from the object to be inspected due to its maintenance at a temperature above zero degrees Kelvin, typically at room temperature or a slightly elevated temperature. Steady state blackbody radiation results from maintaining the object or a portion thereof at a substantially uniform temperature, i.e., in the absence of significant thermal gradients throughout the object or portion thereof being inspected.

The steady state blackbody radiation from the object to be inspected may be generated by holding the object at room temperature. The entire object may be maintained at a substantially uniform temperature at or near room temperature. As used herein, the term “room temperature” means the surrounding ambient temperature found in an area such as a testing laboratory, production facility, warehouse, hanger, airstrip, aircraft cabin or ambient exterior temperature. Room temperatures are typically within a range of from about 60 to about 80° F. However, temperatures above or below such a range may exist. For example, in cold environments such as unheated hangers or warehouses in cold regions, the room temperature may be 32° F. or lower. In warm environments such as non-air-conditioned hangers and warehouses in desert or tropical regions, the “room temperature” may be well above 80° F. e.g., up to 100 or 110° F., or even higher.

Since the substrate 4 is at or near room temperature, it emits a significant amount of substantially steady state infrared (IR) blackbody thermal radiation. In contrast, the coating 2 may be substantially transparent at some of the wavelengths at which the underlying substrate 4 emits the blackbody radiation. Many organic polymers that may be used in the coating 2 are significantly IR-transmissive in certain spectral bands. The blackbody radiation of the substrate 4 can penetrate the organic coating 2 covering the substrate 4 and reveal the surface condition of the substrate 4 under the coating 2. The radiation transmitted through the coating 2 is thus used to provide images from the self-illuminated substrate 4 that reveal any defects under the coating 2. The substrate 4 to be inspected becomes observable by its own IR radiation, which is a function of the temperature of the substrate 4.

In accordance with another embodiment of the present invention, the object to be inspected is held at an elevated temperature, e.g., above room temperature, to maintain an elevated steady state blackbody radiation. Such an elevated temperature may be up to about 120° F. or higher, typically in a range of from 80 to about 110° F. The elevated temperature may be maintained by any suitable means (not shown), such as exposure to sunlight, heat gun, heat lamp, thermal blanket, hot packs, human contact and the like.

Another embodiment of the present invention shown FIG. 2 illustrates a system for detecting structural features of a coated object 1 which utilizes IR illumination and a narrow bandwidth filter. An infrared light source 5 is used to cast infrared light 7 in the direction of an object 1 comprising a substrate which is coated. Prior to reaching the object 1, the infrared light may optionally pass through a first polarizer 21. The first polarizer 21 is operative to polarize the infrared light to a first selected polarity.

Reflected infrared light 9 passes through an optional second polarizer 23. The second polarizer 23 is operative to polarize the reflected light to a second selected polarity. For instance, the second polarizer 23 may be configured to polarize the reflected infrared light 9 in a direction opposite to that of first selected direction, a method known as cross-polarity. In this case, light of the polarity modulated by the first polarizer 21 will not pass through the second polarizer 23. Polarizers may not be necessary in many instances because most coatings are not polarized in any certain orientation.

The portion of the reflected infrared light 9 which was reflected off of regular areas of the substrate will retain the polarity modulated by the first polarizer 21 and therefore will not pass through the second polarizer 23. However, the portion of the reflected infrared light 9 which was reflected off of irregular areas, such as corrosion or rust, will have an altered polarity and will therefore pass through the second polarizer 23. Additionally, this optional polarization technique can reduce scattering by pigments in the coating which results in a clearer image of the substrate. Thus, only the portion of the infrared light 7 which was reflected off irregular areas of the substrate will pass through the second polarizer 23. The first polarizer 21 and second polarizer 23 may therefore operate in tandem to highlight the areas of the substrate which are irregular because they are corroded or otherwise damaged. Additionally, the polarity modulated by the first polarizer 21 may be configured to allow viewing of the substrate at various levels. This is because light of a polarity parallel to the substrate will more easily reflect off of the coating, while light of a polarity perpendicular to the substrate will more easily penetrate through the coating to the substrate beneath. Accordingly, it is possible to focus either on the surface of the substrate itself or on the surface of the coating. This methodology may be combined with the cross-polarity method described above in order to enhance particular features of the substrate at a particular level. It should be noted that although the first polarizer 21 and second polarizer 23 may be used in the fashion described and are therefore present in a potentially preferred embodiment, they are not necessary to the function of the present invention, and need not be included. Furthermore, the filter system described above need not be limited to cross-polarity at 90 degrees. Cross-polarity is described by way of example and more beneficial polarity setting may be utilized.

In accordance with an embodiment of present invention, the reflected infrared light 9 may also pass through a spectral filter 22 as shown in FIG. 2. The resulting image 19 is maybe captured on a detector 8. Coatings used on, for instance, aircraft components and assemblies are generally designed to be opaque in the visible range of light. Often, they are more transparent in the infrared range of light. Accordingly, certain wavelengths of light are more likely to pass through the coating to be reflected by the substrate beneath. The image 19 created by the portion of the infrared light having these wavelengths will represent an image primarily of the substrate instead of the coating on the substrate. It is therefore desirable to focus on these wavelengths to the exclusion of others, and they become the selected wavelengths passed by the spectral filter 22. The filter 22 need not be a single filter, but could be a series of filters, in order to tailor the bandpass wavelength to a specific wavelength range.

The detector 8 may selectively detect radiation at certain wavelengths at which the coating is substantially transparent. In this manner, the coating does not substantially interfere with the image of the substrate 4. The detector 8 is included as part of an infrared camera 20 which detects infrared radiation (˜750 nm to ˜1 mm). The detector 8 is typically a narrow gap semiconductor, e.g. Indium Antimonide. The IR camera can be any commercially available unit capable of detection in the IR range and particularly in the mid-IR range or near-IR range. Depending on the detector, IR cameras of the present invention may utilize the mid-IR range of about 3 microns to about 5 microns and about 8 to about 12 microns or the camera may utilize the near-IR range of about 2.5 nanometers to about 750 nanometers.

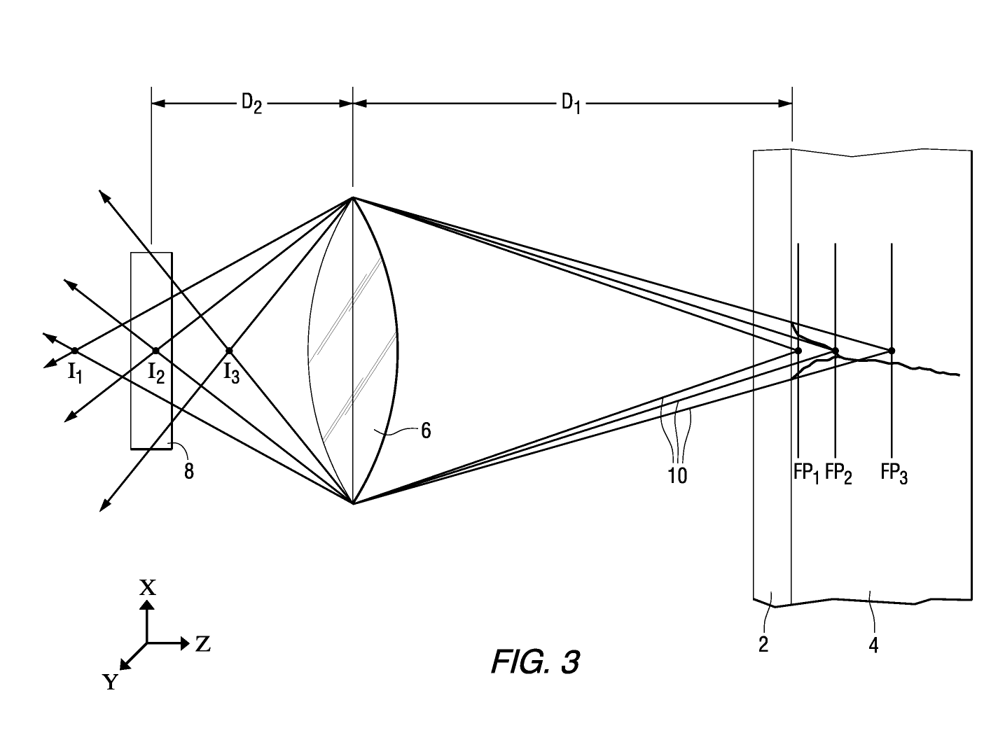

Referring now to FIG. 3, the present invention improves the inspection of a coated substrate by providing the observer with clearer images of the substrate. IR cameras receive incident light rays 10 reflected or emitted from a subject through a convex lens 6. The incident light rays 10 may be received from various focal planes, FP₁, FP₂ and FP₃. The lens 6 converges the incident light rays 10 to a focal point a short distance away. If the lens 6 is in a fixed focal position, each focal plane will best be seen through the lens 6 when D₁, which is the distance from the lens to the substrate-coating interface, corresponds to its image, I₁, I₂ or I₃. This can be accomplished by varying D₁. The camera may be moved along D₁ by using a calibrated jig or stand.

In another embodiment, the lens focus can be changed to vary the focal plane while the remainder of the camera is stationary. In this embodiment, D₂ in FIG. 3 varies by moving the lens 6 slightly relative to the infrared detector 8 while D1 remains fixed. While only one lens 6 is shown in FIG. 3 for illustrative purposes, in actual practice multiple lenses are used in an infrared camera 20. Altering the focus of the lens 6 will move I₁ or I₃ onto the infrared detector 8 and into focus. When using an embodiment of the invention wherein focus is used to change the focal plane, calibration of the focus mechanism to determine D₁ is desirable. Providing an accurate dimension for D₁ produces a more reliable software model.

I₂ in FIG. 3 corresponds to the most focused point of FP₂. However, focal planes, FP₁ and FP₃ are likely to be visible yet unfocused. The range of depth of the substrate visible in a single image is termed “depth of field”. For simplicity, focal planes are described and visualized as two dimensional as shown. Increased and decreased depth around the focal plane remains visible but less focused as distance from the focal plane is increased. The z-axis corresponds to this distance and is perpendicular to each focal plane.

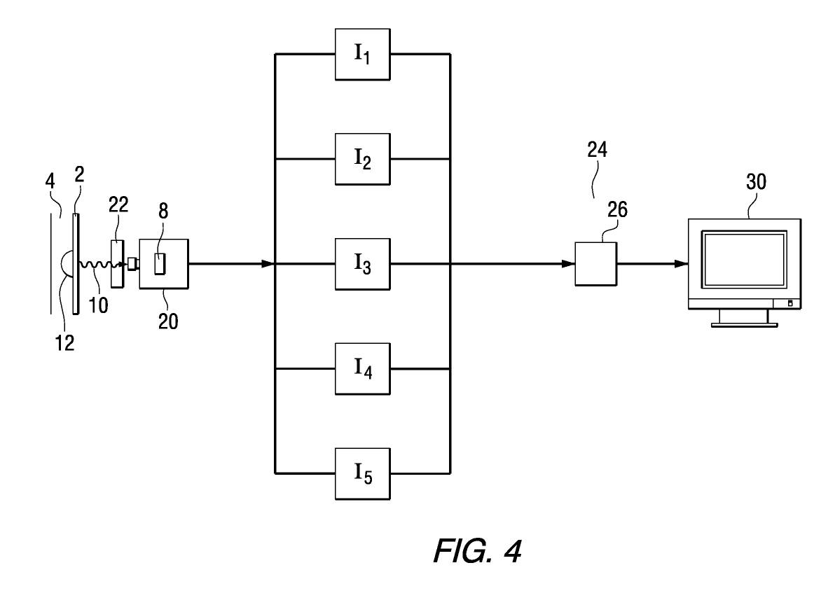

Referring now to FIG. 4, an IR camera 20 with spectral filter 22 takes a series of images (I₁, I₂, I₃, I₄ and I₅) of a pit 12 in a substrate 4 under a coating 2 at different focal planes. Each image will have a focused portion corresponding to the focal plane selected. By recording multiple digital images at varying depths, data is collected that allows for the production of a single image in focus at many depths. The digital data for each image may be stored locally on the camera 20 or communicated to a computer. The recorded images may then be merged or stacked using software 26 using appropriate algorithms to process the digital data of each image. The algorithm may use the focused portion for each image to produce an image that is in focus for a much greater depth of field than could be achieved using traditional methods. The software incorporates algorithms to select the focused portion of each image and integrate each focused portion into a single image. The portion of individual images used is a function of the number of images selected to be taken between the top focal plane and the bottom focal plane. The focused portion of each image is stacked with the focused portions of the other images. The stack is then merged using software 26 of a computer to create one merged image. The merged image 27 may be stored or displayed, e.g. on a computer monitor 30, as a two-dimensional figure at this point. Further image processing may convert the merged image into a three-dimensional model 28, which may also be stored or displayed on the computer monitor 30.

Again referring to FIG. 4, detector 8 may selectively detect radiation at certain wavelengths at which the coating 2 is substantially transparent. In this manner, the coating 2 does not substantially interfere with the image from the substrate 4 or the pit 12. The detector 8 may include any suitable device such as an IR camera, IR detector, IR focal plane or the like. For example, the camera may be an analog or digital camera, and may record still or video images. The detector 8 may include a portable or movable camera such as a hand-held camera or a camera that may be mounted on a tripod or the like that can be moved by means of a pan feature and/or a tilt feature. Infrared cameras may be used, for example, cameras which detect mid-infrared radiation, e.g., having wavelengths between about 3 and about 5 microns. Such mid-IR wavelengths have been found to produce relatively sharp images with minimal interference from several types of coatings.

In addition to the camera 20, the spectral filter 22 may optionally be positioned in the optical path of the blackbody radiation between the substrate 4 and the detector 8. The spectral filter 22 removes portions of the blackbody radiation having wavelengths at which the coating 2 is non-transparent, e.g., wavelengths below 3.7 or 3.75 micrometers are removed, and wavelengths above 5.0 micrometers are removed.

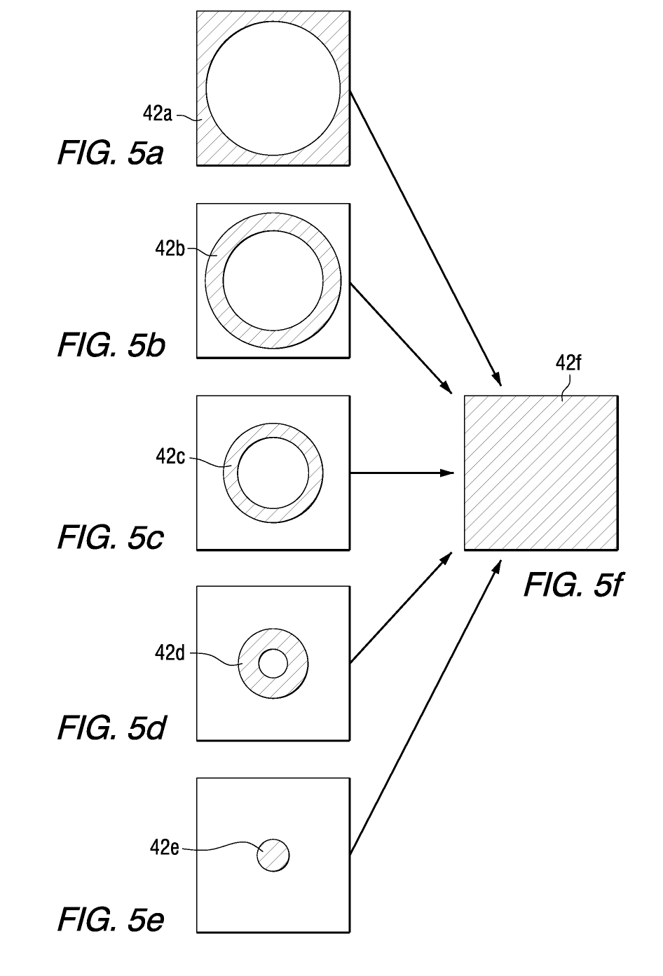

In FIGS. 5a-e, illustrations of focused portions 42a-e are shown as they may appear in single images at different focal depths. The observer may be able to detect some portion of a pit in each image, but details of the size and depth of the pit are not clear. By using a stacking algorithm, the present invention combines these images into one focused image 42 as shown in FIG. 5f that can clearly display topographical information such as width and depth of the pit under the coating. Merging, computer image processing, computer modeling, image fusion and image integration are other terms used to describe the stacking process mentioned above.

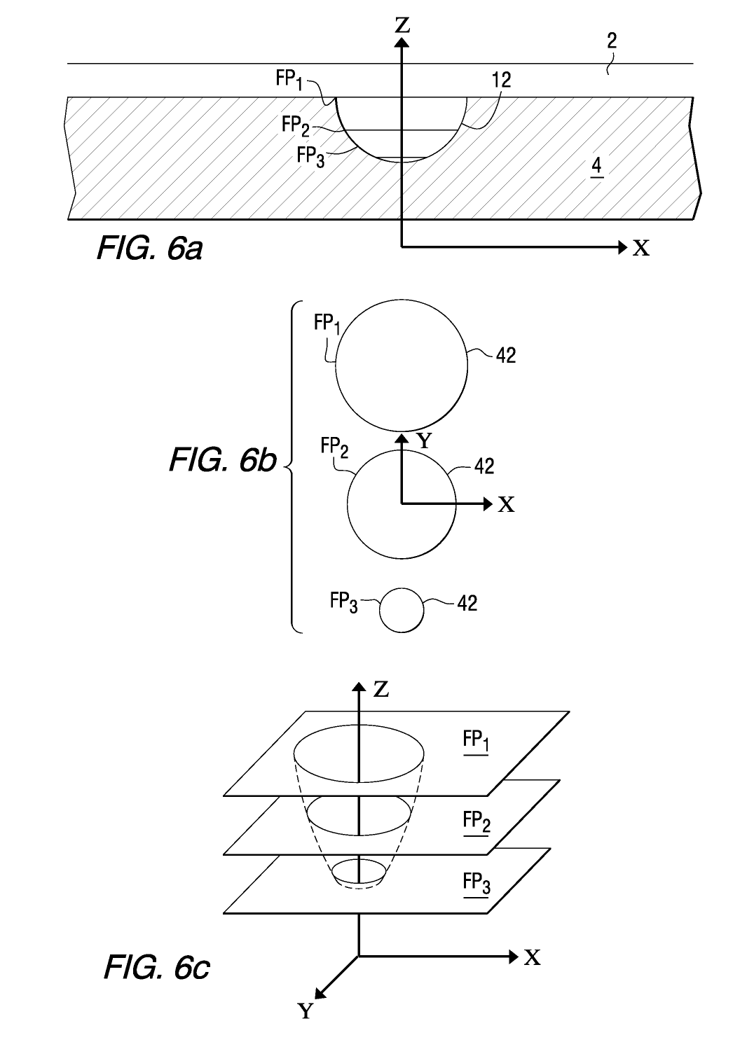

Infrared cameras convert IR radiation to an analog or digital signal. As the makeup of the surface of a substrate changes so too does the IR radiation produced by the surface. IR cameras are able to detect these changes and portray them as an image. Referring to FIGS. 6a-c, at each focal plane (FP₁, FP₂, FP₃) a different section of the pit will be in focus. For each focal plane, only a portion of the pit is in focus. By focusing at varying known depths. A graphic representation of a three dimensional image of the substrate can be created as illustrated by FIG. 6c.

The software used for merging the individual images may select only in-focus portions of each image and exclude the remaining out of focus portions of each image. This may be based on a multi-resolution method where the in-focus portions of each image are selected by determining the high frequency components of the image. The frequency analysis may be accomplished via wavelet or Fourier Transform.

Another method for selecting in-focus portions of different images uses a variance method where portions of the image around a single coordinate are evaluated. The image having higher variations in intensity is selected for that coordinate.

In another embodiment, the software compares each pixel with the same coordinates in the various images and selects the most in focus based on a predetermined selection rule.

Commercially available software sold under the designation Auto Multi Focus by Hirox Company may be adapted for use in accordance the present invention to collect the focused portion of each image and to merge those focused portions into a complete image. Other suitable software may be used.

In accordance with an embodiment of the present invention, the filtered image of the substrate, including the detected structural features, may be compared with a reference image. For example, a reference image may be generated from another object similar to the coated object that is known to be substantially free of defects. By comparing a substantially defect-free reference object to the coated object being inspected, manual or automated evaluations may be performed. The reference image used as the standard could be preprogrammed into a database and a comparison made between the reference image and the image created from paint under test. Acceptability criteria could be preprogrammed as well. For example, unacceptable areas could be highlighted in red and acceptable areas in green. Other colors could be selected, as well, such as gray for an area requiring more evaluation.

The f-number, also called f-ratio or f-stop, of an optical system expresses the diameter of the entrance pupil in terms of the effective focal length of the lens. It is well known in traditional photography that adjustments to the f-number impact depth of field for the image. The same is true for IR imaging. Consequently, an improved merged image will result if an f-number corresponding to a relatively narrow depth of field is selected for all images and the number of images taken at different focal planes is increased.

Transfer of the image data from the camera to a computer may be accomplished locally via a cable, serial or wireless connection. Additionally, image transfer over a wider network via the Internet is possible.

Before or after merging, the images may be conveyed to the user. Conveying can include displaying, storing or printing the images. The images may be displayed locally on a screen of the IR camera or, alternatively, may be displayed on a separate monitor, plotter or printer. Additionally, individual images may be stored locally on memory included as part of the camera 20, but typically, the images are transferred to a computer for storage prior to being merged.

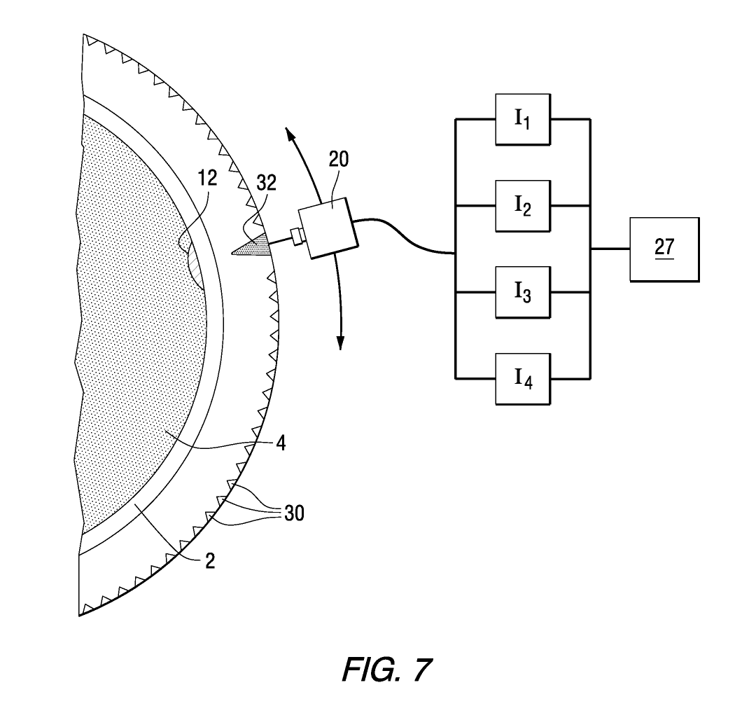

FIG. 7 represents one embodiment of the invention; an IR camera 20 is used to inspect a coated object 1, e.g. a hull of an aircraft, at scan points 30. Single images are taken until an abnormality, e.g. a pit 12, is detected at point 32. At point 32, multiple images are taken at varying focal planes. The images are converted into a three-dimensional image 27 to enable the observer to make an informed decision as to further action.

The following example is intended to illustrate the various aspects of the present invention and is not intended to limit the scope of the invention.

### EXAMPLE 1

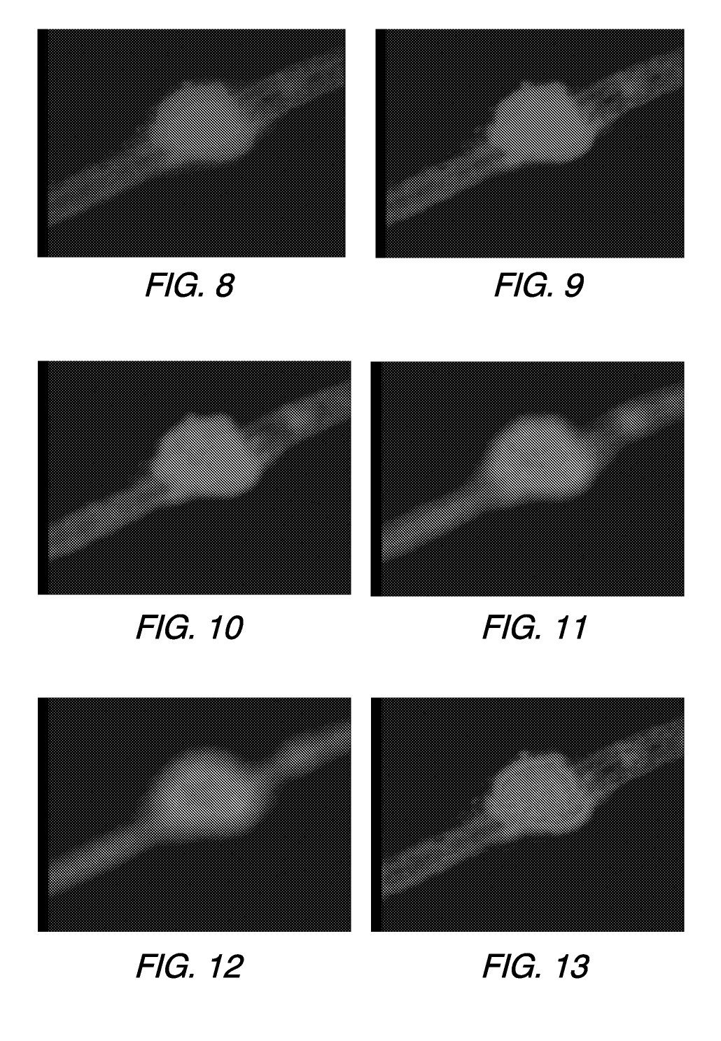

TABLE 1

| | Depth in | |
|---|---|---|
| Photo Number | Microns | Figure Number |
| 1 | 0 | FIG. 8 |
| 2 | 25 | |
| 3 | 50 | |
| 4 | 75 | |
| 5 | 100 | FIG. 9 |
| 6 | 125 | |
| 7 | 150 | |
| 8 | 175 | |
| 9 | 200 | FIG. 10 |
| 10 | 225 | |
| 11 | 250 | |
| 12 | 275 | |
| 13 | 300 | FIG. 11 |
| 14 | 325 | |
| 15 | 350 | |
| 16 | 375 | |
| 17 | 400 | FIG. 12 |
| 18 | 425 | |
| 19 | 450 | |
| 20 | 475 | |
| 21 | 500 | |

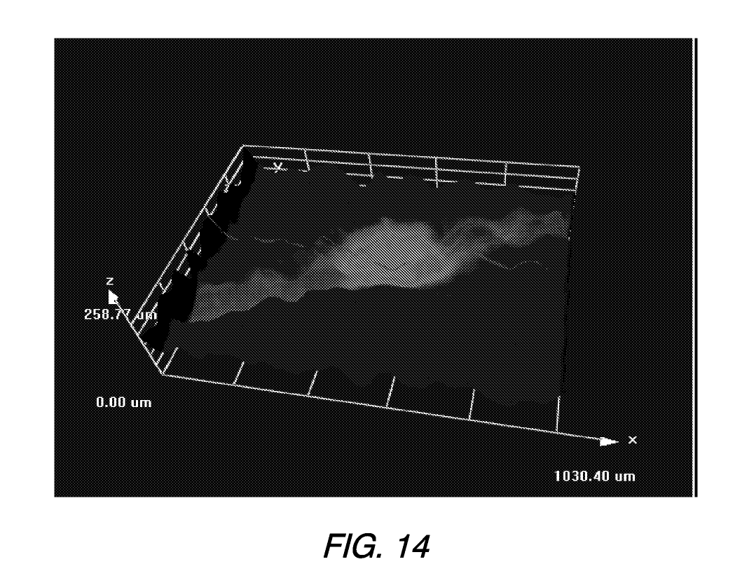

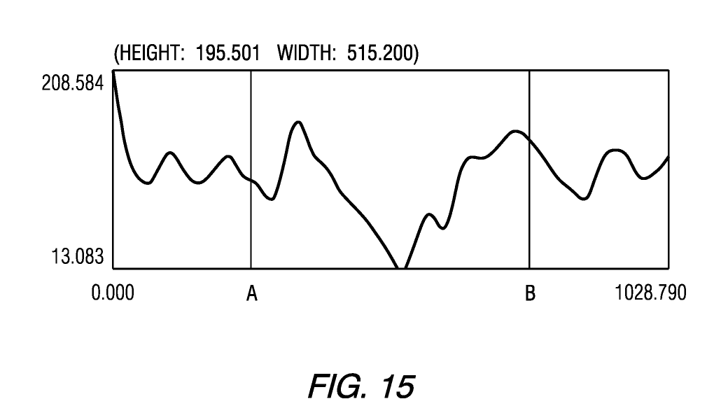

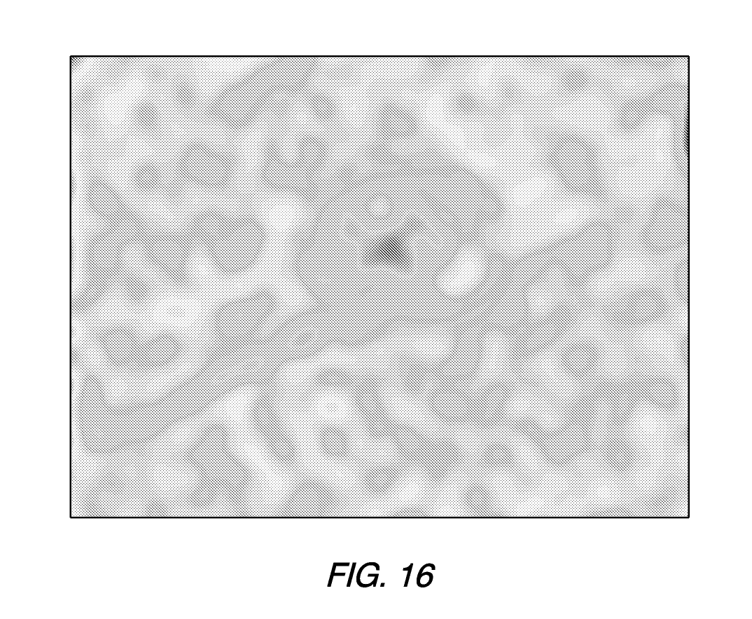

An infrared camera was focused on an area of a substrate containing a pit which was covered by a coating. The camera was mounted on a calibrated stage to measure the depth of each photo. An organic paint type coating was applied over a corrosion pit, which was inscribed as a channel on a panel. The pit was produced on an unpainted scribe on the panel by salt fog (ASTM B117) and then the panel was painted with the organic coating. Multiple IR photos were taken at varying focal planes. Table 1 lists the depth of each photo taken. Figures corresponding to photo number 1, 5, 9, 13 and 17 are shown as FIGS. 8-12 respectively. FIG. 13 shows a merged image of photos 1-21 shown in Table 1. As can be plainly seen comparing FIG. 13 to the individual photos shown in FIGS. 8-12 that a dramatic improvement in the depth field is realized through the present invention. The images in this example were combined using the auto multi focus software described above. FIG. 14 shows a three dimensional model of the merged image of FIG. 13. A cross-section of the image of the pit shown in FIG. 14 is shown in FIG. 15 where width and depth of the pit may be calculated. FIG. 16 shows a topographical view of the pit shown in FIGS. 8-15, where color or shading can provide a detailed view of the surface contours of the substrate under a coating.

Whereas particular embodiments of this invention have been described above for purposes of illustration, it will be evident to those skilled in the art that numerous variations of the details of the present invention maybe made without departing from the invention as defined in the appended claims.

1. A system for imaging a substrate through a coating on the substrate, comprising:
an infrared camera to receive infrared radiation from the substrate at different focal planes, wherein the infrared camera converts the infrared radiation to an image at each focal plane;
means for combining the images at the different focal planes into a merged image; and
a device for conveying the merged image.

2. The system of claim 1, wherein the means for combining the images at the different focal plane into one image comprises a computer in communication with the infrared camera and software installed on the computer capable of combining the images into one merged image.

3. The system of claim 1, wherein a first one of the images has an in-focus portion, a second one of the images has an in-focus portion, and the focused image comprises tin focus portions of the first and second images.

4. The system of claim 1, wherein one of the focal planes is at a surface of the substrate and another one of the focal planes is below the surface of the substrate.

5. The system of claim 1, wherein at least two planes are below the surface of the substrate.

6. The system of claim 1, wherein the infrared radiation from the substrate comprises blackbody radiation.

7. The system of claim 1, wherein the infrared radiation from the substrate comprises reflected infrared radiation.

8. The system of claim 1, further comprising a heat source to increase the infrared radiation emitted from the substrate.

9. The system of claim 1, wherein the substrate is an aircraft component.

10. The system of claim 1, wherein the coating material comprises paint, a composite matrix material, primer, top coat or intermediate coat.

11. The system of claim 1, wherein the infrared camera comprises a spectral filter.

12. The system of claim 1, wherein only focused portions of each image are combined into the focused image.

13. A system for imaging a transmissive non-metallic material, comprising:
an infrared camera to receive infrared radiation from the material at different focal planes within the material, wherein the infrared camera converts the infrared radiation to an image at each focal plane;
means for combining the images at the different focal planes into a merged image; and
a device for conveying the merged image.

14. A method for imaging a substrate through a coating on the substrate, comprising:
receiving infrared radiation from the substrate into an infrared camera;
focusing the camera on a first focal plane of the substrate;
recording a first image at the first focal plane;
focusing the camera on a second focal plane of the substrate;
recording a second image at the second focal plane; and
merging the first and second images together to form a focused image.

15. The method of claim 14, further comprising recording at least one additional image between the first focal plane and second focal plane.

16. The method of claim 15, wherein all focal planes a parallel.

17. The method of claim 14, wherein the focused image is a two-dimensional image.

18. The method of claim 14, wherein the focused image is a three-dimensional image.

19. The method of claim 14, wherein only focused portions from the first and second images are to form the focused image.

20. A method for imaging a coating on the substrate, comprising:
receiving infrared radiation from the substrate into an infrared camera;
adjusting the distance between the camera and the substrate to focus the camera on a first focal plane of the substrate;
recording an image at the first focal plane;
adjusting the distance between the camera and the substrate to focus the camera on a second focal plane of the substrate;
recording an image at the second focal plane; and
merging the images of the first and the second focal planes together to form a focused image.
